(19) United States
(12) Patent Application Publication
(10) Pub. No.: US 2021/0117920 A1
(43) Pub. Date: Apr. 22, 2021

(54) PATENT PREPARATION SYSTEM

(71) Applicant: FENIX.AI LLC, Boulder, CO (US)

(72) Inventor: Michael Carey, Boulder, CO (US)

(73) Assignee: FENIX.AI LLC, Boulder, CO (US)

(21) Appl. No.: 17/072,276

(22) Filed: Oct. 16, 2020

Related U.S. Application Data
(60) Provisional application No. 62/915,941, filed on Oct. 16, 2019.

(51) Int. Cl. G06Q 10/10; G06Q 50/18; G06N 5/04; G06F 40/40; G06F 40/279

(52) U.S. Cl. CPC G06Q 10/101; G06Q 50/184; G06F 40/279; G06F 40/40; G06N 5/04

(57) ABSTRACT

Systems and methods for patent preparation using a computer implemented patent preparation tool are described. Embodiments are configured to identify a set of claims including an independent claim and a dependent claim depending from the independent claim, wherein the independent claim includes a plurality of claim limitations, receive input indicating that the dependent claim corresponds to an individual claim limitation of the plurality of claim limitations of the independent claim, store a patent data object in a computer memory, wherein the patent data object includes an indication that the dependent claim corresponds to the individual claim limitation, and generate text for a patent application indicating that the dependent claim corresponds to the individual claim limitation, wherein the text is generated based on the stored patent data object.

### CROSS-REFERENCE TO RELATED APPLICATION

This application claims priority to, and the benefit of, U.S. Provisional Application Ser. No. 62/915,941 filed on Oct. 16, 2019, entitled AUTOMATED PATENT PREPARATION. The entire contents of the foregoing application are hereby incorporated by reference for all purposes.

### BACKGROUND

The following relates generally to patent preparation, and more specifically to computer implemented tools for facilitating patent preparation.

Patent preparation can be an expensive and time intensive process. Therefore, some patent practitioners use tools, such as computer implemented applications for preparing patents in a more time and cost-efficient manner. For example, some patent preparation tools take claims as input and output text for the claims, claim summary, drawings, or specification.

However, in many cases these tools do not capture important aspects of the relationships between the claims. For example, in some cases a dependent claim can represent a more detailed description of a single element of a parent claim such as an independent claim (as opposed to simply depending from the whole claim). Therefore, the text generated by theses tools requires substantial modification. These modifications increase the time and cost associated with patent preparation.

### SUMMARY

The inventive concept relates to a patent preparation system that captures important information about the relationship among claim limitations. For example, embodiments of the inventive concept can receive input (either explicit user input, or input derived from an analysis of a claim set) that indicates that a claim modifies a specific limitation of a parent claims instead of simply depending from the whole claim. The patent preparation system may then store this information in a patent data object and then generate claims, drawings, or specification text that represents the relationship between limitations (i.e., method steps or components) of the dependent claim and specific individual limitations of the parent.

A method, apparatus, non-transitory computer readable medium, and system for patent preparation are described. Embodiments of the method, apparatus, non-transitory computer readable medium, and system are configured to identify a set of claims including an independent claim and a dependent claim depending from the independent claim, wherein the independent claim includes a plurality of claim limitations, receive input indicating that the dependent claim corresponds to an individual claim limitation of the plurality of claim limitations of the independent claim, store a patent data object in a computer memory, wherein the patent data object includes an indication that the dependent claim corresponds to the individual claim limitation, and generate text for a patent application indicating that the dependent claim corresponds to the individual claim limitation, wherein the text is generated based on the stored patent data object.

### BRIEF DESCRIPTION OF THE DRAWINGS

FIG. 1 shows an example of a patent preparation system according to aspects of the present disclosure.

FIGS. 2 through 6 show examples of a process for patent preparation according to aspects of the present disclosure.

### DETAILED DESCRIPTION

The inventive concept relates to a patent preparation system that captures important information about the relationship among claim limitations. For example, embodiments of the inventive concept can receive input (either explicit user input, or input derived from an analysis of a claim set) that indicates that a claim modifies a specific limitation of a parent claims instead of simply depending from the whole claim. The patent preparation system may then store this information in a patent data object (i.e., in a form other than simply storing the text itself that represents the claim structure) and then generate claims, drawings, or specification text that represents the relationship between limitations (i.e., method steps or components) of the dependent claim and specific individual limitations of the parent.

In some cases, the relationship between a dependent claim and an individual limitation might be expressed in the preamble of the dependent claim. For example, if a step of a parent claim reads “processing a message”, the preamble of the dependent claim might read “wherein processing the message further comprises” to indicate that the dependent claim describes the specific limitation of “processing a message” and is not simply a set of additional steps in the process of the parent claim.

Thus, in one embodiment, a user explicitly provides input via a user interface that the dependent claim is related to a specific limitation (also referred to as a feature, or claim feature). Then, the language of the preamble can be automatically generated. Similarly, language can be generated for the description of a flowcharts that indicates the flowchart is a process for performing a specific step of another flowchart, or a claim.

In another embodiment, a user uploads a set of claims, and the structure of the claims and limitations can be inferred from the uploaded claim set (i.e., based on the preamble of a dependent claim). Thus the claim structure includes a complex tree structure in which claim nodes can depend from other claim nodes, but features within a claim can also be related to features from another claim.

Most patent preparation software includes some representation of the tree structure relating claims to other claims (i.e., claim dependency), but it does not include a structural representation of the relationship between claim features or limitations and other claims or limitations. Therefore, these conventional patent preparation tools are incapable of generating preambles, flowcharts, diagrams and specification text that describes this additional structure of the claims.

Therefore, embodiments of the patent preparation system described herein enable an improvement to existing patent preparation technology. Specifically, the inventive concept includes the unconventional feature of identifying and storing a relationship between dependent claims and individual limitations of a parent claim (as opposed to simply representing the dependency of the claims). This enables a user to generate more accurate set of claims, diagrams, flowcharts, and specification text than they would using conventional patent preparation tools.

In some embodiments, the patent preparations system will generate text for drawings, claims, and specification of a patent and either generate document templates, or input the text into pre-made templates. Then, a user may edit, augment, and otherwise improve the patent documents so that they are in condition to be filed with a patent office.

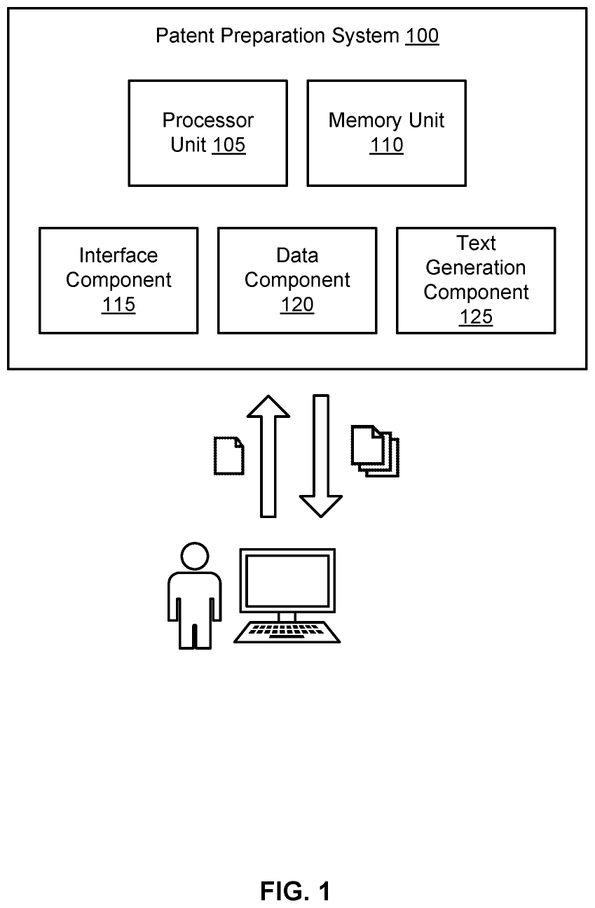

FIG. 1 shows an example of a patent preparation system 100 according to aspects of the present disclosure. In one embodiment, patent preparation system 100 includes processor unit 105, memory unit 110, interface component 115, data component 120, and text generation component 125.

In some cases, the patent preparation system 100 is a software application on a personal computer, laptop computer, mainframe computer, palmtop computer, personal assistant, mobile device, or any other suitable processing apparatus. In other examples, the patent preparation system 100 is located on a cloud server and is accessible to users via the internet.

A processor unit 105 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Examples of a memory unit 110 include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

A user interface may enable a user to interact with a device. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI).

According to some embodiments, interface component 115 identifies a set of claims including an independent claim and a dependent claim depending from the independent claim, where the independent claim includes a set of claim limitations. In some examples, interface component 115 receives input indicating that the dependent claim corresponds to an individual claim limitation of the set of claim limitations of the independent claim.

According to some embodiments, data component 120 stores a patent data object in a computer memory, where the patent data object includes an indication that the dependent claim corresponds to the individual claim limitation.

According to some embodiments, text generation component 125 generates text for a patent application indicating that the dependent claim corresponds to the individual claim limitation, where the text is generated based on the stored patent data object. In some examples, text generation component 125 generates a description of a flowchart representing the dependent claim, where the description of the flowchart includes text indicating that the flowchart represents a process for performing the individual claim limitation.

In some examples, text generation component 125 generates a description of a diagram representing the dependent claim, where the description of the diagram includes text indicating that the diagram includes subcomponents of a component described by the individual claim limitation. In some examples, text generation component 125 generates preamble text for the dependent claim, where the preamble text indicates that the dependent claim corresponds to the individual claim limitation. In some examples, text generation component 125 determines a number of steps for a flowchart representing the dependent claim based on the input, where the determination includes a determination of whether to include each of the set of claim limitations of the independent claim.

A patent preparation system can have a variety of top level sections corresponding to input sections, document sections, navigation/search, configuration and save/load/print tabs.

The input sections can include one or more sections primarily devoted to importing, creating, editing and arranging inputs (especially features and elements, which correspond to claims and figures/components). The document sections include sections corresponding directly to a patent document, including cross-references, background, summary, brief description, detailed description, glossary, abstract, etc.

The configuration section enables the user to import and edit configurable elements such as sentence templates. Acronyms may also be specified in the configuration section. A search/navigation section may enable a user to find and load information related to a specific patent.

A patent is made up of a variety of sections including a cross-references section, a background section, a summary section, a brief description section, a detailed description section, an abstract section, a claims section, etc. In some cases, one or more of these sections can have a section structure. The structure can include instructions to include one or more sentence templates. In some cases, the number of sentences that are included in a section may be dynamically determined based on the template structure.

For example, a summary section may have a structure that includes a certain set of sentences for each independent claim. As another example, inclusion of a sentence may depend on whether an element has a parent (or child) element. A brief description may have a structure that includes a sentence (or paragraph) for each figure. Thus, the structure can include a set of sentences or instructions for including sentences. In some examples, certain sections (i.e., claims and figures) may be used as the basis for determining the structure of other section (e.g., claim summary and brief description, respectively).

In some cases, the section logic is encoded in a user interface tool. In other examples, it is configurable by the user. In some cases, the sentence templates are configurable, and may be stored in a database unique to a user or client. In some cases, a user may have more than one set of configurable sentence templates associated with different clients or application types. Thus, a user may select an application template, and import the appropriate set of sentence templates based on that application template.

Sentences can be constructed based on sentence templates. Sentence templates may be data structures that include variables, functions, and connecting text. Example variables include features and elements (e.g., text variables). Example functions can include numbering, formatting, conjugation, declension, etc. In some cases, variables that are input into sentence templates may correspond to features and elements.

A component of the patent preparation system may be the relationship between elements (also referred to as entities, components etc.) and features (also known as information, limitations, sentences, details, limitations steps, etc.). An element is an entity which can either be physical (i.e., a memory, processor, circuit, housing, etc.) or conceptual (message, software component, model, algorithm, etc.). A feature is a sentence, phrase, or collection of sentences or phrases that provides relationships among elements, or information about an element.

Natural language processing or other algorithms may be used to identify elements from a set of features. For example, parts of speech (i.e., nouns and adjectives) can be identified and used to identify elements. In some cases, an element can be associated with a feature even if it doesn't appear in the text of a feature (e.g., a feature may represent an action performed by an element). In some cases, this association is made explicit by a user (e.g., by selecting an implicit element in a drop don menu associated with a feature). In other cases it is inferred (e.g., using a machine learning model or an algorithm).

Users can add features and elements manually, and edit them. In some cases, when an element is edited, all instances of that element in various features may also be edited. In some cases, each element has a plural form and a singular form. Active features may have different forms based on verb conjugation (i.e., infinitive, gerund, present).

One role of a patent practitioner is to make sure that each of the features and elements supported in the claims is supported in the specification. A patent preparation system may assist in doing this. Once an association is made between a feature and an element, additional sentences can be created in when that feature or element shows up in the specification. For example, a sentence may state that an element can perform an action, or describe an embodiment of an element. Alternatively, when a feature is presented as a step or detail, a sentence can be added stating that the action may be performed by one or more particular elements, including where those elements are described in the specification.

Elements and features may be grouped and structured using one or more lists and trees. For example, a set of features may be grouped together as a claim, a process, or a set of details. Each set of features may be associated with a parent feature (i.e., if a set of steps can be substeps of another step). Elements can also be grouped and structured. For example, an component may have a number of subcomponents.

In some cases, elements and features can be numbered. The numbering can be associated with a location in a drawing or specification where the feature is described. For example, elements that show up in FIG. 1 can be numbered with a label starting with ‘1’.

In some cases, an indication may be provided to a user that one or more elements are not sufficiently described in the specification. For example, in some cases, elements can be associated with a particular description (which may be a features) that is established as the definition of the element. Elements that do not have a definition may be flagged or highlighted to the user. Elements that do not show up in a figure may be highlighted to the user. Elements that do not show up in a feature may be flagged or highlighted.

In some cases, the flagging or highlighting may depend on whether the element shows up in a feature that is associated with an independent claim, or a dependent claim, or no claim at all. For example, elements that show up in independent claims may be prioritized such that only these elements are flagged or highlighted, or the indications are more visible.

In some cases, a set of features may be indicated as duplicates (e.g., if they contain the same or similar information, but are formatted or constructed differently). In some cases, only one from a set of duplicate sentences may be included where otherwise a logical structure would cause both/all of them to be included.

In some cases, additional features (or other forms of information) about an element may be imported from a database or an online platform such as DBpedia. In some cases, sets of elements or features can be used to automatically construct claim or figure data structures.

Thus, the relationships among features and among elements, and between features and elements can be used to automatically create patent content, or to indicate to a user where more content would be desirable. Creating content may happen in the form of taking one structure of features and/or elements and creating another structure (i.e., for use in another section of a patent) or by algorithmically creating a new structure based on a combination of features and/or elements. For example, a figure may be generated from a portion of a tree structure on elements. Similarly, claims can be created from structures on features (i.e., from an outline form to a claim form). Claim dependency can be inferred from the outline form. Similarly, figure structures can be inferred from parent or child relationships among element. In some embodiments, a user interface allows a user to select features or elements to use in creation of a new claim or figure.

Indicating that more content is desirable can be a function of identifying features or elements in the claims, and indicating whether they are appropriately supported in the specification. For example, a patent preparation system may identify elements that appear in an independent claim, and create a warning (or a highlighting of the element or feature) if that element doesn't have a definition, or if it doesn't show up in a figure as a numbered element.

In some cases, a system may also identify terms that can or should be generalized. For example, if a term is a proper noun, a patent preparation system can suggest that an umbrella term be created and that the proper noun be included as an example.

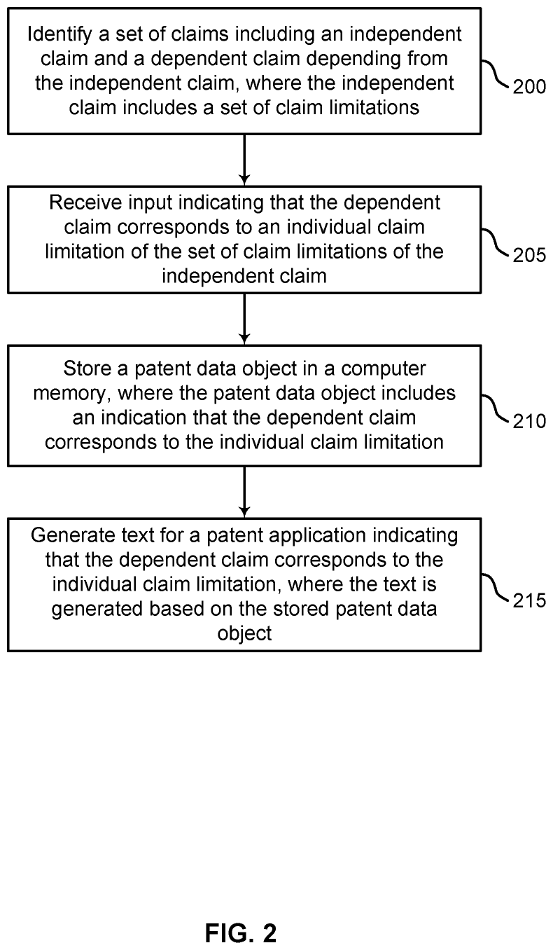

FIG. 2 shows an example of a process for patent preparation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 200, the system identifies a set of claims including an independent claim and a dependent claim depending from the independent claim, where the independent claim includes a set of claim limitations. In some cases, the operations of this step refer to, or may be performed by, an interface component as described with reference to FIG. 1.

At operation 205, the system receives input indicating that the dependent claim corresponds to an individual claim limitation of the set of claim limitations of the independent claim. In some cases, the operations of this step refer to, or may be performed by, an interface component as described with reference to FIG. 1.

At operation 210, the system stores a patent data object in a computer memory, where the patent data object includes an indication that the dependent claim corresponds to the individual claim limitation. In some cases, the operations of this step refer to, or may be performed by, a data component as described with reference to FIG. 1.

At operation 215, the system generates text for a patent application indicating that the dependent claim corresponds to the individual claim limitation, where the text is generated based on the stored patent data object. In some cases, the operations of this step refer to, or may be performed by, a text generation component as described with reference to FIG. 1.

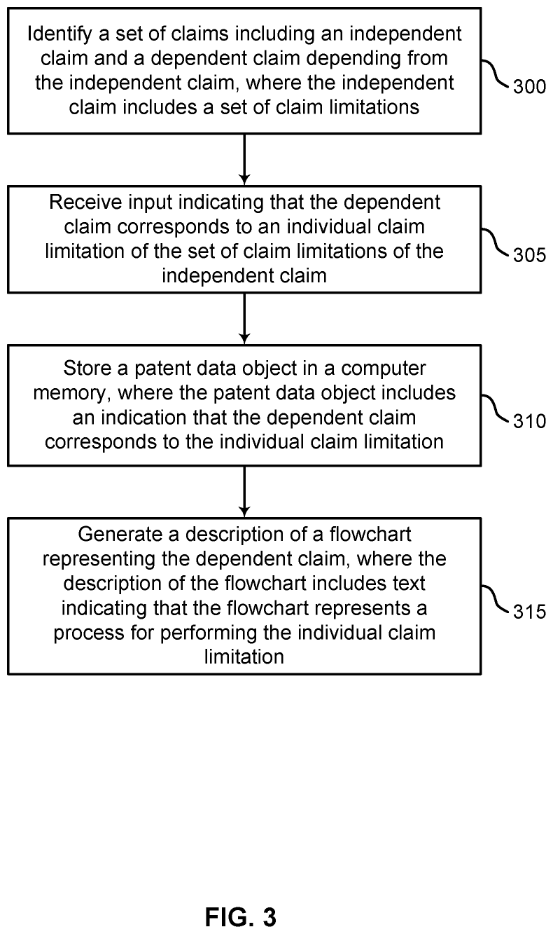

FIG. 3 shows an example of a process for patent preparation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 300, the system identifies a set of claims including an independent claim and a dependent claim depending from the independent claim, where the independent claim includes a set of claim limitations. In some cases, the operations of this step refer to, or may be performed by, an interface component as described with reference to FIG. 1.

At operation 305, the system receives input indicating that the dependent claim corresponds to an individual claim limitation of the set of claim limitations of the independent claim. In some cases, the operations of this step refer to, or may be performed by, an interface component as described with reference to FIG. 1.

At operation 310, the system stores a patent data object in a computer memory, where the patent data object includes an indication that the dependent claim corresponds to the individual claim limitation. In some cases, the operations of this step refer to, or may be performed by, a data component as described with reference to FIG. 1.

At operation 315, the system generates a description of a flowchart representing the dependent claim, where the description of the flowchart includes text indicating that the flowchart represents a process for performing the individual claim limitation. In some cases, the operations of this step refer to, or may be performed by, a text generation component as described with reference to FIG. 1.

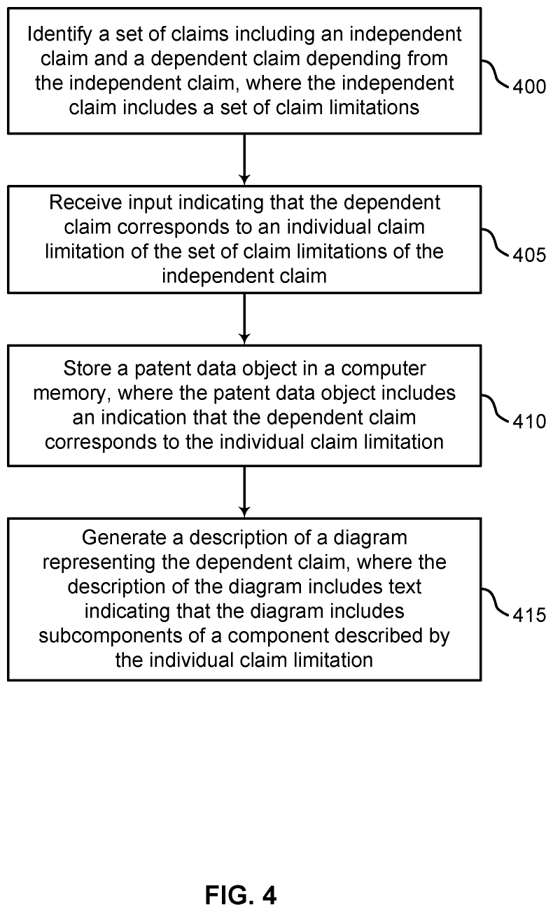

FIG. 4 shows an example of a process for patent preparation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 400, the system identifies a set of claims including an independent claim and a dependent claim depending from the independent claim, where the independent claim includes a set of claim limitations. In some cases, the operations of this step refer to, or may be performed by, an interface component as described with reference to FIG. 1.

At operation 405, the system receives input indicating that the dependent claim corresponds to an individual claim limitation of the set of claim limitations of the independent claim. In some cases, the operations of this step refer to, or may be performed by, an interface component as described with reference to FIG. 1.

At operation 410, the system stores a patent data object in a computer memory, where the patent data object includes an indication that the dependent claim corresponds to the individual claim limitation. In some cases, the operations of this step refer to, or may be performed by, a data component as described with reference to FIG. 1.

At operation 415, the system generates a description of a diagram representing the dependent claim, where the description of the diagram includes text indicating that the diagram includes subcomponents of a component described by the individual claim limitation. In some cases, the operations of this step refer to, or may be performed by, a text generation component as described with reference to FIG. 1.

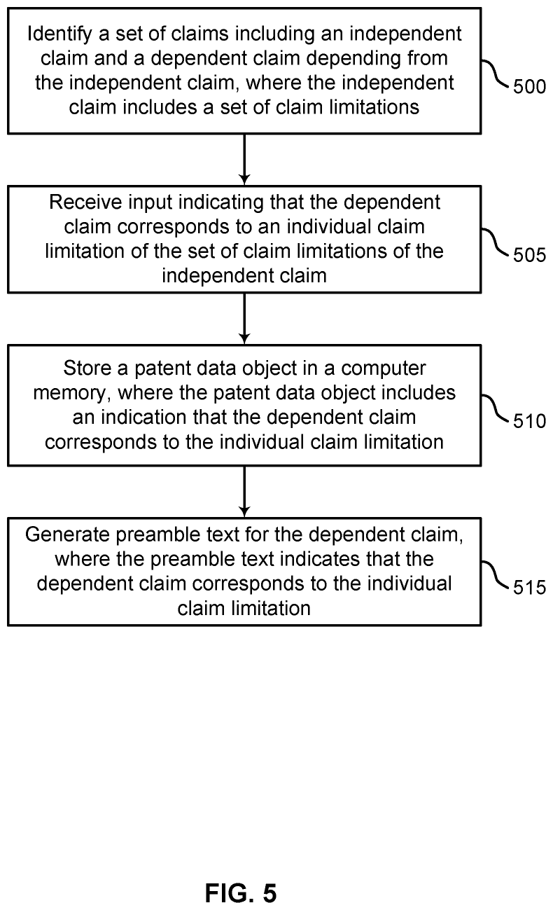

FIG. 5 shows an example of a process for patent preparation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 500, the system identifies a set of claims including an independent claim and a dependent claim depending from the independent claim, where the independent claim includes a set of claim limitations. In some cases, the operations of this step refer to, or may be performed by, an interface component as described with reference to FIG. 1.

At operation 505, the system receives input indicating that the dependent claim corresponds to an individual claim limitation of the set of claim limitations of the independent claim. In some cases, the operations of this step refer to, or may be performed by, an interface component as described with reference to FIG. 1.

At operation 510, the system stores a patent data object in a computer memory, where the patent data object includes an indication that the dependent claim corresponds to the individual claim limitation. In some cases, the operations of this step refer to, or may be performed by, a data component as described with reference to FIG. 1.

At operation 515, the system generates preamble text for the dependent claim, where the preamble text indicates that the dependent claim corresponds to the individual claim limitation. In some cases, the operations of this step refer to, or may be performed by, a text generation component as described with reference to FIG. 1.

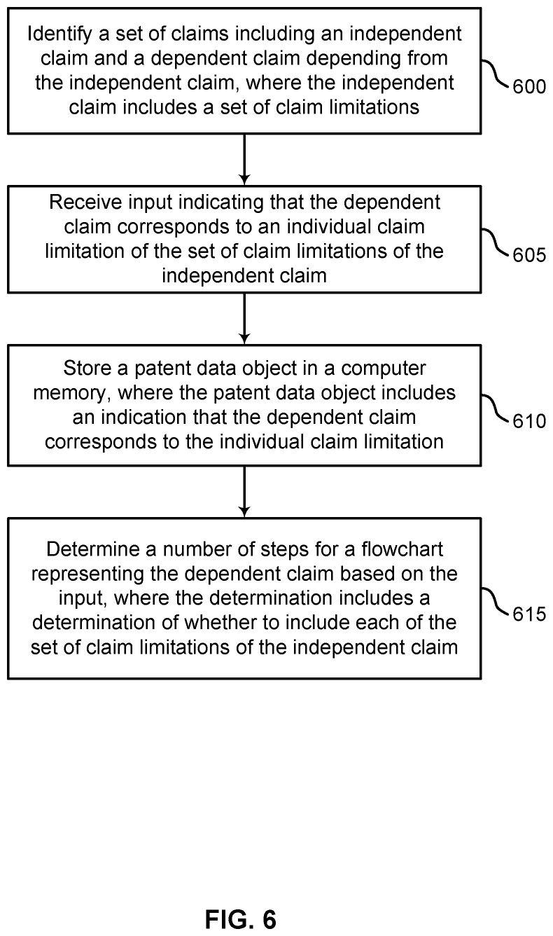

FIG. 6 shows an example of a process for patent preparation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 600, the system identifies a set of claims including an independent claim and a dependent claim depending from the independent claim, where the independent claim includes a set of claim limitations. In some cases, the operations of this step refer to, or may be performed by, an interface component as described with reference to FIG. 1.

At operation 605, the system receives input indicating that the dependent claim corresponds to an individual claim limitation of the set of claim limitations of the independent claim. In some cases, the operations of this step refer to, or may be performed by, an interface component as described with reference to FIG. 1.

At operation 610, the system stores a patent data object in a computer memory, where the patent data object includes an indication that the dependent claim corresponds to the individual claim limitation. In some cases, the operations of this step refer to, or may be performed by, a data component as described with reference to FIG. 1.

At operation 615, the system determines a number of steps for a flowchart representing the dependent claim based on the input, where the determination includes a determination of whether to include each of the set of claim limitations of the independent claim. In some cases, the operations of this step refer to, or may be performed by, a text generation component as described with reference to FIG. 1.

The term limitation may refer to a portion of a claim such as description of a single component in an apparatus claim or a single step of a method claim. Limitations may also be referred to as features. However, a “feature” may include both claim limitations and details that ultimately do not show up in the claims. A feature may or may not be a complete sentence, but it may convey a relationship between elements. Each feature is associated with one or more elements (i.e., nouns or verbs). Elements. An element can be a component of a device, a product of a step, an input, etc. For example, a claim feature “transmit a message to a base station” includes the elements message (explicit), base station (explicit), mobile device (implicit—the one doing the transmitting)

In some cases, multiple organizational structures can be imposed on the same set of features. There structures may include:

Claims. A claim consists of a preamble, a set of child features (which may include the preamble or a portion of the preamble), a set of child claims, and other configuration parameters (e.g., whether verbs in a method claims are going to be in gerund or infinitive form). Claims are organized into trees. Each application has a single set of claims which can include one or more independent claims (top level nodes) and the corresponding dependent claims (child claims). There are also structures within claims, such as an indication of whether a dependent claim modifies a claim as a whole, or a limitation of the claim.

A diagram is a type of figure that imposes structure primarily on elements or components of an apparatus. A diagram has a description, and a set of child components. Each component can also have child components. Each component points to an element.

A flowchart is another a type of figure. Both diagrams and flowcharts may be displayed together so the user can order them. A flowchart is an ordered list of features that can also include internal links. For example, steps 1 and 2 of a flowchart may both be inputs to step 3, which may have two outputs: 4 and 5. A flowchart may include loops based on the links.

In some cases, a user may create a document outline for an application. An outline is a tree structure on the features that can be used to generate claims or other language in the specification. Unlike claims, diagrams and flowcharts, the outline is an intermediate product, so that it may not correspond directly to any part of the specification.

Content is a structure on the features of an application that includes paragraphs (groups of features) that are associated with figures (either a diagram or a flowchart). Content can also be associated with other sections of the application like the background, introduction, etc.

In some cases, a user may include a glossary that associates certain elements with a particular feature (the definition). A patent preparation tool may include an interface for specifying terms to be included in a glossary. An acronym is an alternative name for an element. In some cases a patent preparations system may find and replace acronyms with long form versions of the acronym. A patent preparation tool may include an interface for specifying acronyms to be replaced.

Accordingly, the present disclosure includes the following embodiments.

A method for patent preparation is described. Embodiments of the method are configured to identifying a set of claims including an independent claim and a dependent claim depending from the independent claim, wherein the independent claim includes a plurality of claim limitations, receiving input indicating that the dependent claim corresponds to an individual claim limitation of the plurality of claim limitations of the independent claim, storing a patent data object in a computer memory, wherein the patent data object includes an indication that the dependent claim corresponds to the individual claim limitation, and generating text for a patent application indicating that the dependent claim corresponds to the individual claim limitation, wherein the text is generated based on the stored patent data object.

An apparatus for patent preparation is described. The apparatus includes a processor, memory in electronic communication with the processor, and instructions stored in the memory. The instructions are operable to cause the processor to identify a set of claims including an independent claim and a dependent claim depending from the independent claim, wherein the independent claim includes a plurality of claim limitations, receive input indicating that the dependent claim corresponds to an individual claim limitation of the plurality of claim limitations of the independent claim, store a patent data object in a computer memory, wherein the patent data object includes an indication that the dependent claim corresponds to the individual claim limitation, and generate text for a patent application indicating that the dependent claim corresponds to the individual claim limitation, wherein the text is generated based on the stored patent data object.

A non-transitory computer readable medium storing code for patent preparation is described. In some examples, the code comprises instructions executable by a processor to: identify a set of claims including an independent claim and a dependent claim depending from the independent claim, wherein the independent claim includes a plurality of claim limitations, receive input indicating that the dependent claim corresponds to an individual claim limitation of the plurality of claim limitations of the independent claim, store a patent data object in a computer memory, wherein the patent data object includes an indication that the dependent claim corresponds to the individual claim limitation, and generate text for a patent application indicating that the dependent claim corresponds to the individual claim limitation, wherein the text is generated based on the stored patent data object.

Some examples of the method, apparatus, non-transitory computer readable medium, and system described above further include generating a description of a flowchart representing the dependent claim, wherein the description of the flowchart includes text indicating that the flowchart represents a process for performing the individual claim limitation.

Some examples of the method, apparatus, non-transitory computer readable medium, and system described above further include generating a description of a diagram representing the dependent claim, wherein the description of the diagram includes text indicating that the diagram includes subcomponents of a component described by the individual claim limitation.

Some examples of the method, apparatus, non-transitory computer readable medium, and system described above further include generating preamble text for the dependent claim, wherein the preamble text indicates that the dependent claim corresponds to the individual claim limitation.

Some examples of the method, apparatus, non-transitory computer readable medium, and system described above further include determining a number of steps for a flowchart representing the dependent claim based on the input, wherein the determination includes a determination of whether to include each of the plurality of claim limitations of the independent claim.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a web site, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for patent preparation, comprising:
identifying a set of claims including an independent claim and a dependent claim depending from the independent claim, wherein the independent claim includes a plurality of claim limitations;
receiving input indicating that the dependent claim corresponds to an individual claim limitation of the plurality of claim limitations of the independent claim;
storing a patent data object in a computer memory, wherein the patent data object includes an indication that the dependent claim corresponds to the individual claim limitation; and
generating text for a patent application indicating that the dependent claim corresponds to the individual claim limitation, wherein the text is generated based on the stored patent data object.

2. The method of claim 1, further comprising:
generating a description of a flowchart representing the dependent claim, wherein the description of the flowchart includes text indicating that the flowchart represents a process for performing the individual claim limitation.

3. The method of claim 1, further comprising:
generating a description of a diagram representing the dependent claim, wherein the description of the diagram includes text indicating that the diagram includes subcomponents of a component described by the individual claim limitation.

4. The method of claim 1, further comprising:
generating preamble text for the dependent claim, wherein the preamble text indicates that the dependent claim corresponds to the individual claim limitation.

5. The method of claim 1, further comprising:
determining a number of steps for a flowchart representing the dependent claim based on the input, wherein the determination includes a determination of whether to include each of the plurality of claim limitations of the independent claim.

6. An apparatus for patent preparation, comprising: a processor and a memory storing instructions and in electronic communication with the processor, the processor being configured to execute the instructions to:
identify a set of claims including an independent claim and a dependent claim depending from the independent claim, wherein the independent claim includes a plurality of claim limitations;
receive input indicating that the dependent claim corresponds to an individual claim limitation of the plurality of claim limitations of the independent claim;
store a patent data object in a computer memory, wherein the patent data object includes an indication that the dependent claim corresponds to the individual claim limitation; and
generate text for a patent application indicating that the dependent claim corresponds to the individual claim limitation, wherein the text is generated based on the stored patent data object.

7. The apparatus of claim 6, the processor being further configured to execute the instructions to:
generate a description of a flowchart representing the dependent claim, wherein the description of the flowchart includes text indicating that the flowchart represents a process for performing the individual claim limitation.

8. The apparatus of claim 6, the processor being further configured to execute the instructions to:
generate a description of a diagram representing the dependent claim, wherein the description of the diagram includes text indicating that the diagram includes subcomponents of a component described by the individual claim limitation.

9. The apparatus of claim 6, the processor being further configured to execute the instructions to:
generate preamble text for the dependent claim, wherein the preamble text indicates that the dependent claim corresponds to the individual claim limitation.

10. The apparatus of claim 6, the processor being further configured to execute the instructions to:
determine a number of steps for a flowchart representing the dependent claim based on the input, wherein the determination includes a determination of whether to include each of the plurality of claim limitations of the independent claim.

11. A non-transitory computer readable medium storing code for patent preparation, the code comprising instructions executable by a processor to:
identify a set of claims including an independent claim and a dependent claim depending from the independent claim, wherein the independent claim includes a plurality of claim limitations;
receive input indicating that the dependent claim corresponds to an individual claim limitation of the plurality of claim limitations of the independent claim;
store a patent data object in a computer memory, wherein the patent data object includes an indication that the dependent claim corresponds to the individual claim limitation; and
generate text for a patent application indicating that the dependent claim corresponds to the individual claim limitation, wherein the text is generated based on the stored patent data object.

12. The non-transitory computer readable medium of claim 11, the code further comprising instructions executable by the processor to:
generate a description of a flowchart representing the dependent claim, wherein the description of the flowchart includes text indicating that the flowchart represents a process for performing the individual claim limitation.

13. The non-transitory computer readable medium of claim 11, the code further comprising instructions executable by the processor to:
generate a description of a diagram representing the dependent claim, wherein the description of the diagram includes text indicating that the diagram includes subcomponents of a component described by the individual claim limitation.

14. The non-transitory computer readable medium of claim 11, the code further comprising instructions executable by the processor to:
generate preamble text for the dependent claim, wherein the preamble text indicates that the dependent claim corresponds to the individual claim limitation.

15. The non-transitory computer readable medium of claim 11, the code further comprising instructions executable by the processor to:
determine a number of steps for a flowchart representing the dependent claim based on the input, wherein the determination includes a determination of whether to include each of the plurality of claim limitations of the independent claim.
